(19) United States
(12) Patent Application Publication
(10) Pub. No.: US 2024/0204533 A1
(43) Pub. Date: Jun. 20, 2024

(54) CYBER-RESILIENT SLIDING MODE CONSENSUS-BASED DISTRIBUTED CONTROL SYSTEM FOR AC MICROGRIDS AND METHOD FOR OPERATING SAME

(71) Applicant: UNIVERSITY OF LOUISIANA AT LAFAYETTE, Lafayette, LA (US)

(72) Inventors: Farzad Ferdowsi, Lafayette, LA (US); Ali Jafarian Abianeh, Lafayette, LA (US); Raju Gottumukkala, Lafayette, LA (US); Tomislav Dragioevic, Lafayette, LA (US)

(73) Assignee: UNIVERSITY OF LOUISIANA AT LAFAYETTE, Lafayette, LA (US)

(21) Appl. No.: 18/542,645

(22) Filed: Dec. 16, 2023

Related U.S. Application Data
(60) Provisional application No. 63/433,402, filed on Dec. 16, 2022.

(51) Int. Cl. H02J 3/38; G05B 19/042; H02J 3/12

(52) U.S. Cl. CPC H02J 3/388; G05B 19/042; H02J 3/12; H02J 3/381

(57) ABSTRACT

A cyber-resilient consensus based distributed control systems for islanded AC microgrids to enhance the resilience of distributed control in the secondary layer comprising a modified sliding surface benefits from the presence of a cyber-resilient offset compensation term as it ensures retaining the minimum levels of deviations under both normal and cyber-corrupted conditions in the secondary layer. The system includes a hysteresis-based communication link quality observer, which ensures that the cyber intrusion levels are bounded to specific levels. Using this approach along with offset compensation term on the surface as well as the boundary layered based switching function, a chattering free steady state performance is ensured.

### CROSS REFERENCE TO RELATED APPLICATIONS

This application claims priority to U.S. Provisional Application No. 63/433,402 titled SLIDING MODE CONSENSUS BASED CONTROL SCHEME filed on Dec. 16, 2022.

### STATEMENT REGARDING FEDERALLY SPONSORED RESEARCH OR DEVELOPMENT

Not applicable.

### Reference to a “Sequence Listing,” a Table. or a Computer Program

Not applicable.

### FIELD OF THE INVENTION

The field of this inventions is design and control of distributed control system for islanded AC microgrids by utilizing sliding mode consensus-based methods for the hardening of control systems against cyberattacks.

### DESCRIPTION OF THE DRAWINGS

The drawings constitute a part of this specification and include exemplary embodiments of the CYBER-RESILIENT SLIDING MODE CONSENSUS-BASED DISTRIBUTED CONTROL SYSTEM AND METHOD FOR OPERATING SAME, which may be embodied in various forms. It is to be understood that in some instances, various aspects of the invention may be shown exaggerated or enlarged to facilitate an understanding of the invention. Therefore, the drawings may not be to scale. For purposes of clarity, not every component may be labeled in every drawing.

FIG. 1A is a general control block diagram of the typical control architecture of grid forming converters known in the art.

FIG. 1B is a general control block diagram of the typical control architecture of grid following converters known in the art.

FIG. 2 is a simplified block diagram for a grid-forming converter connected to the common electric bus.

FIG. 3 is a line diagram showing the relation between P-ω, and Q-V variables and the possible regulation strategies by means of primary and secondary controllers.

FIG. 4 is a block diagram of the local controller on a grid-forming converter in the presence of the secondary layer regulation terms.

FIG. 5 is a block diagram of the conventional consensus-based secondary control scheme.

FIG. 6A is a flowchart showing the classification of a denial-of-service attack on the communication link in the secondary control layer.

FIG. 6B is a flowchart showing the classification of a false data injection attack on the communication link in the secondary control layer.

FIG. 7 is a block diagram of the disclosed cyber-resilient sliding mode consensus-based secondary control scheme.

FIG. 8 is a block diagram of the disclosed hysteresis-based communication link quality observer.

FIG. 9 is an electrical diagram for the distributed control system of an islanded AC microgrid consisting of three integrated Distributed Energy Resources (DERs) and dynamic loading.

FIG. 10 is a table providing the electrical specifications for the DERs and the four-quadrant load utilized during testing of the control system shown in FIG. 9.

FIG. 11 is a table providing the local control parameters for the three DERs utilized during testing of the control system shown in FIG. 9.

FIG. 12 is a table providing the secondary control parameters for the three DERs utilized during testing of the control system shown in FIG. 9.

FIG. 13 is a table providing the quantified performance function values before minor FDI attacks for both conventional and proposed consensus schemes.

FIG. 14 is a table providing the performance functions are quantified over a 5-second period where at t=0, the minor 2% FDI attack is asserted on the frequency or voltage terms.

FIG. 15 is a table providing the calculated resilience index values from testing.

FIG. 16A is a graph of the frequency performance of the conventional consensus scheme under a minor (2% offset) voltage and frequency FDI attack.

FIG. 16B is a graph of the voltage performance of the conventional consensus scheme under a minor (2% offset) voltage and frequency FDI attack.

FIG. 16C is a graph of the active power performance of the conventional consensus scheme under a minor (2% offset) voltage and frequency FDI attack.

FIG. 16D is a graph of the reactive performance of the conventional consensus scheme under a minor (2% offset) voltage and frequency FDI attack.

FIG. 17A is a graph of the frequency performance of the disclosed SMC consensus secondary control under load steps and different levels of frequency FDI attacks (2%, 20%, 40% offset).

FIG. 17B is a graph of the active power performance of the disclosed SMC consensus secondary control under load steps and different levels of frequency FDI attacks (2%, 20%, 40% offset).

FIG. 17C is a graph of the sliding scale performance of the disclosed SMC consensus secondary control under load steps and different levels of frequency FDI attacks (2%, 20%, 40% offset).

FIG. 18A is a graph of the frequency performance of the disclosed SMC consensus secondary control under load steps and different levels of active power FDI attacks (10%, 30%, 60% offset).

FIG. 18B is a graph of the active power performance of the disclosed SMC consensus secondary control under load steps and different levels of active power FDI attacks (10%, 30%, 60% offset).

FIG. 18C is a graph of the sliding surface performance of the disclosed SMC consensus secondary control under load steps and different levels of active power FDI attacks (10%, 30%, 60% offset).

FIG. 19A is a graph of the voltage performance of the disclosed SMC consensus secondary control under load steps and different levels of voltage FDI attacks (10%, 30%, 60% offset).

FIG. 19B is a graph of the reactive power performance of the disclosed SMC consensus secondary control under load steps and different levels of voltage FDI attacks (10%, 30%, 60% offset).

FIG. 19C is a graph of the sliding scale performance of the disclosed SMC consensus secondary control under load steps and different levels of voltage FDI attacks (10%, 30%, 60% offset).

FIG. 20A is a graph of the voltage performance of the disclosed SMC consensus secondary control under Q demand step and different levels of Q-FDI attacks (10%, 30%, 60% offset) grid following.

FIG. 20B is a graph of the reactive power performance of the disclosed SMC consensus secondary control under Q demand step and different levels of Q-FDI attacks (10%, 30%, 60% offset) grid following.

FIG. 20C is a graph of the sliding surface performance of the disclosed SMC consensus secondary control under Q demand step and different levels of Q-FDI attacks (10%, 30%, 60% offset) grid following.

### BACKGROUND OF THE INVENTION

Power generation based on renewable energy resources is an inevitable approach in response to an ever-increasing degradation of fossil fuel-based resources. However, the intermittent nature of green power resources such as solar and wind does not allow the complete elimination of conventional systems. During the past few decades, microgrids have gained much higher popularity as they could potentially address this intermittency issue while offering a comprehensive solution for grids highly penetrated by Distributed Energy Resources (DERs). Due to the low penetration level of such facilities into the existing utility grids, they are predominantly configured in the grid following mode of operation while relying on the rigid and high inertia grids dominated by the synchronous generators. New challenges have emerged as more low inertia power electronics-based converters are integrated into the grid. The main concerns are associated with their grid forming operation mode which is also crucial when the converters enter the islanded mode.

Grid forming mechanisms are typically implemented in the art through hierarchical cascaded control loops. With this architecture, the local controllers are devoted to the voltage and frequency regulation where droop compensation terms further alleviate the impedance effect introduced by the power delivery lines. The main control objectives in the secondary layer are enhancing the voltage/frequency sharing and the active/reactive power sharing between the distributed energy resources. The highest level in this hierarchical control scheme is assigned to the tertiary level that coordinates with the power utility through energy management policies.

In decentralized topologies currently known in the art, DERs are configured in the standalone mode where local controllers are adjusted for voltage and frequency regulation based on local measurements, while incorporating the conventional droop terms. However, there are several drawbacks to this approach including poor voltage, frequency, and power sharing performance between the adjacent DERs; inevitable trade-off between control time constant and voltage/frequency sharing performance; and performance deterioration on the non-purely resistive or inductive power lines. To address the aforementioned issues, several modifications have been made by those skilled in the art using the virtual frame, virtual impedance, adaptive droop, and signal injection method. Due to the nature of decentralized controllers, some levels of voltage and frequency deviations as well as poor power sharing always persist. The secondary controllers have aimed to resolve these shortcomings through introducing an additional regulatory term to the local controllers' setpoints. Centralized controllers were conventionally employed for this purpose, but they encounter a single point of failure, which makes the system highly vulnerable. Therefore, those skilled in the art turned their focus to distributed controllers, which can overcome most difficulties associated with centralized controllers while ensuring a superior sharing performance compared to the decentralized ones.

The two most common types of distributed control schemes are based on averaging and consensus techniques. In the averaging algorithm, the secondary control term is calculated based on the average of all available shared signals in a strongly connected network, but the consensus scheme is formed based on adaptive convergence to the consensus value calculated between neighboring signals with optimally reduced networking connections. Despite the superior dynamic response, the averaging scheme suffers from an extreme communication burden which hinders its widespread application. The consensus based distributed control algorithm has thus been widely adopted by those having skill in the art using multi-agent systems. Multi-agent systems (MAS) comprise loosely coupled networks of software agents that interact to solve problems that are beyond the individual capacities or knowledge of each problem solver.

Among the consensus schemes known in the art, some have focused on compensating the deviation levels on the local voltage and frequency terms, while others aimed to attain a superior power sharing performance. Some of those skilled in the art have combined these two approaches and proposed solutions to the multi-objective sharing operation using tunable compromise gains and a two-layer cascaded regulation approach. However, the performance of these conventional consensus algorithms can deteriorate under presence of system nonlinearities and uncertainties.

To address the aforementioned challenges, advanced control methods such as Model Predictive Control (MPC), Sliding Mode Control (SMC) and artificial intelligence/machine learning are employed for distributed secondary control of microgrids. From a high level, MPC is a control scheme that uses a model for predicting the future behavior of a system over a finite time window (i.e., the horizon). The SMC technique regulates the behavior of a dynamical system by pushing the state of the system onto a predefined sliding surface to make the sliding surface attractive for the system trajectory.

In one approach known in the art, a discrete model is employed to predict the future behavior of microgrids and improve system stability. The cost function for this method only considers the terms for prediction error compensation and control effort minimization. The predictive control concept is also incorporated by the schemes where a state feedback linearization scheme is also integrated. All these MPC based schemes are model-driven, and the inaccuracies in their underlying models make them highly prone to performance deterioration in presence of the model's uncertainties and external disturbances. In addition, the massive computation burden involved in such schemes hinders their practical implementation. The application of solely data-driven based artificial-intelligent algorithms to the distributed consensus schemes is not popular due to challenges associated with its training process for all possible operating conditions and the vulnerability of the system to the overfitting phenomenon. Some schemes have integrated them with MPC or used it to imitate the more computationally dense MPC algorithms. The main drawback to this approach is the difficulty of collecting a proper training dataset based on different MPC behavioral states in the presence of disturbances. Furthermore, the performance of such algorithms is usually biased by the training data quality which leads to misrepresentation of some specific operating conditions and poor performance.

To address the challenges associated with the model-based and data-driven distributed control algorithms, the model-independent SMC consensus scheme has been investigated by many of those skilled in the art. The SMC consensus scheme can outperform the model-based schemes in the presence of uncertainties, as the discontinuous control function forces the state variables toward the specified manifolds and ensures its robust performance. Without solely relying on datasets or a trial-and-error corrective process, its robust performance in the presence of microgrid parameter variations, disturbances and other system uncertainties is ensured.

In one approach known in the art, a Sliding Mode Consensus (SMC) voltage sharing scheme is reported which accounts for the transmission delays on the shared voltage signals. However, the chattering effect of this scheme is not addressed, and it lacks the secondary control over frequency and power signals. In another approach, those skilled in the art have proposed a chattering-free voltage and frequency sharing scheme using the sliding mode concept, but this scheme also does not address the power sharing requirements. In another approach known in the art, the active power sharing concept is added to the sliding mode consensus voltage and frequency sharing, but the chattering effect is also not properly mitigated. In addition, the proposed sliding surface suffers from deviations due to the inevitably compromised regulation nature between the frequency and active power sharing schemes. In another prior art approach, a sliding mode voltage-frequency and active-reactive power sharing scheme is reported, but this scheme also fails to address the challenges associated with the sliding surface deviations. Most of the SMC based consensus schemes known to those skilled in the art have only attempted to enhance the disturbance rejection performance of system under loading disturbances or improve the system resilience against minor cyber irregularities such as communication delays. None of them have verified their performance against cyberattacks, which are the challenging type of disturbances to the distributed consensus schemes.

Distributed control-based AC microgrids can be envisioned as a Cyber-Physical System (CPS) with integrated hardware/software components, communications, and sensors. Distributed control strategies are vulnerable to cyber-attacks primarily due to the abundance of communication links and lack of proper intrusion detection units. Cybersecurity is reported as one of the most prominent contributing factors to a microgrid's resilience. It is known to those skilled in the art that cyber disturbances are capable of completely corrupting a system, resulting in a microgrid's instability and power outages.

Those skilled in the art have investigated Denial of Service (DOS) and False Data Injection (FDI) as two of the most common types of cyberattacks, emphasizing their severe impacts on the distributed sharing systems. The stability of the islanded AC microgrids under random DOS attacks has been studied by those skilled in the art using a stochastic analysis approach. The effect of FDI attacks on the load sharing performance and the FDI impact on a multi-objective consensus distributed control scheme have also been studied by those skilled in the art. Unlike the DOS attacks that target the availability of communication, FDI interferes with the data integrity over communication lines. FDIs are usually asserted through manipulating the communication protocols as well as the parameter settings on the inverters.

Most detection schemes in smart grids are targeted for grid infrastructures, and generally can be categorized into two main groups of model-based and data-driven schemes. The most popular method among model-driven schemes is Kalman filtering. However, these schemes are strictly dependent on the system parameters and the model, and unavoidable modeling uncertainties can lead to erratic operations and false detection. Furthermore, the excessive complexity of such algorithms, especially when regression is involved, undermines their feasibility.

To address the model dependency challenges associated with such detection schemes, data-driven algorithms are employed by those skilled in the art. Most of these schemes utilize either supervised or unsupervised learning. Reinforcement Learning (RL) is scarcely used by those skilled in the art. The main drawback to these detection methods is the requirement for extensive training which might not cover all the possible system operating conditions. This could also lead to an over-fitting challenge, where a system only performs well for the selected data samples and not for the whole population of possible measurements. The trial-and-error based nature of RL learning also makes the system prone to unfamiliar and complicated attack types as it fails to systematically explore the cyber-attack space. In addition, the complexity of such schemes exponentially grows with the system's scale, which makes it unfeasible. Instead of using these complex detection schemes, the model-independent distributed observers could better fulfill the requirements of the microgrids as emerging distributed generation units.

In another approach known in the art, a distributed observer based on trust-and-confidence factors is employed for ensuring a cyber-secure frequency sharing performance. However, this approach lacks the solution to cyberattacks on the distributed voltage and power sharing schemes. In one approach offered as a cyber-resilient solution for consensus-based voltage sharing, the communication link quality is measured as a function of power angle to ensure a certain level of system resilience. This same approach is also applied for voltage and frequency regulation where tunable compromising gains are applied for incorporating the active and reactive power sharing into the distributed scheme. The main drawback of this method is the higher vulnerability of loosely connected networks to cyberattacks. In addition, relying on the power angle terms of DERs for detection of cyberattacks cannot be a feasible approach on microgrids dominated by non-synchronous generation units because the system performance becomes highly dependent on the installed micro-Phasor Measurement Units (PMUs) over electrical buses.

The presence of numerous intercommunication links between the distributed agents make such control schemes prone to cyberattacks. Such intrusions can be asserted through the external manipulation of the communication layers resulting in a corrupted operation and malfunctions. These malicious attacks may target the availability, integrity and confidentiality of the cyber sections within the cyber-physical systems. Among different types of cyberattacks, false data injection (FDI) and denial of service (DOS) are discussed in this section as two common types of attacks.

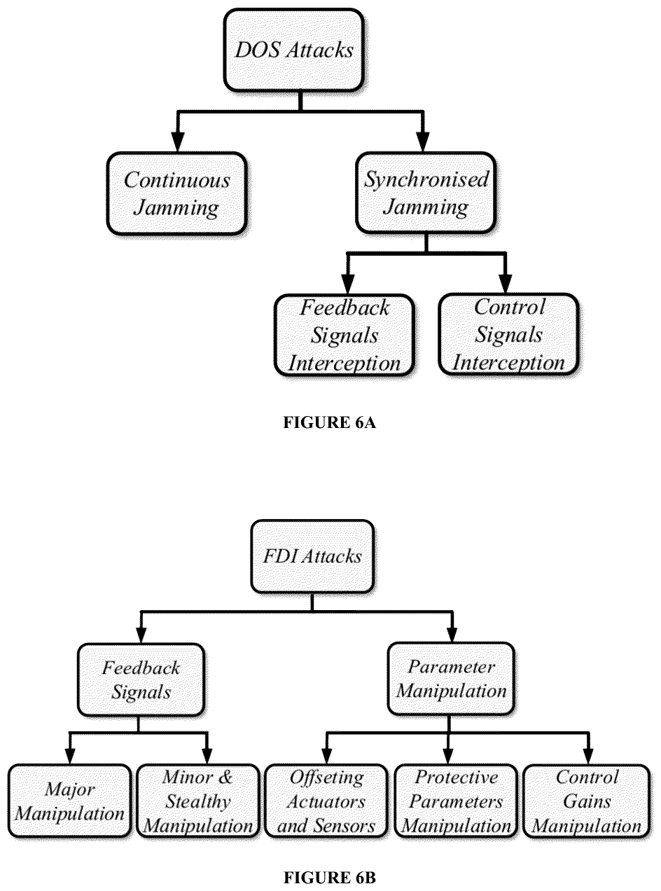

As the DOS term suggests, the attacker aims to make a severe disruption of the communication service either momentarily or for an extended time. This is usually initiated through flood in the communication links with the scam data packets which occupy the bandwidth and makes the agents unresponsive to some specific or complete set of other commands and requests. In some extreme cases, the impact of DOS could be intensified by means of subsequent firmware modification and credential thefts. A general classification of the DOS attacks on the secondary control layer is depicted in FIG. 6(a). While the continuous jamming can completely intercept the communication link, the synchronized jamming can be more challenging to detect as the intrusion targets specific data packets through synchronizing with their moment of transmission. In comparison with the FDI attacks, the DOS is easier to be detected at the early stages resulting in less complex mitigation methods.

Unlike the DOS causing unavailability of the data packets, the false data injection targets the data integrity over the communication links. This type of intrusion is basically initiated through the malicious manipulation of the cyber data packets in different levels of the microgrid hierarchical control scheme. Since the focus of this paper is the investigation of the destructive impacts made by such attacks on the secondary control layer, the discussion about other layers is not presented here. A general classification for the false data injection types of attacks on the secondary control layer is presented in FIG. 6(b). The injection of the false data can be either for malicious modification of the shared feedback signals sent by agents or poor adjustment of the local controllers. The former is usually asserted through additive or multiplicative modification of the distributed feedback terms including voltage, frequency, active and reactive powers. The modification levels can be different as some FDI attacks can potentially make significant deviations in actual signals, while others intend to remain hidden by applying minor changes. The FDI attacks can also access the parameter setting of the local controllers through the secondary layer which is enabled for remote operation and maintenance purposes. Thus, it is possible to poorly adjust the parameters related to the controllers, protection units as well as the analog local measurement interfaces.

### SUMMARY OF THE INVENTION

To overcome the limitations of prior art approaches, here disclosed is a cyber-resilient sliding mode consensus based distributed control scheme for islanded AC microgrids. To mitigate the shortcomings of sliding surface deviations on the combined secondary sharing schemes, a modified sliding surface is proposed, which benefits from the presence of a cyber-resilient offset compensation term in the proposed SMC. This ensures minimum deviations under both normal and cyber-corrupted conditions in the secondary layer. To avoid excessive sliding gain values for improving the system's robustness, a hysteresis-based communication link quality observer is disclosed, ensuring that the cyber intrusion levels are bounded to specific levels. Using this approach along with offset compensation term on the sliding surface as well as the boundary layered based switching function ensures a chattering free steady state performance. Unlike other prior art communication link quality observers which only rely on the power angle terms and intensify the communication vulnerability due to requirements for PMU communications, the scheme disclosed herein only utilizes the available distributed terms. To verify the effectiveness of the proposed scheme, the inventors tested a real-time model of an islanded AC microgrid developed using a real time emulator. The disclosed control scheme achieves a more efficient cyber resilient approach by combining the robustness of a sliding mode control scheme with the communication link observers to avoid the need for excessively high sliding control gains. This scheme also eliminates the need for the PMU communications as a part of the cybersecurity scheme and considered both high and low inertia DERs for analysis of the system's dynamic response to cyberattacks.

### DETAILED DESCRIPTION OF THE INVENTION

The term “islanded alternating current (AC) microgrid” is generally used to refer to a set of DERs connected to a common electrical bus using different interconnection topologies while the connection to the infinite bus of the utility grid is eliminated. The DERs can be represented by any power generation unit including both renewable and non-renewable sources. In preferred embodiments, a hierarchical multi-layered regulation scheme is implemented to maintain the microgrid local variables of voltage and frequency within the permissible range. The preferred embodiment is arranged in a hierarchical scheme divided into a primary level #, a secondary level #, and a tertiary level #. The primary development of this invention is on the secondary level, so this disclosure focuses on the primary and secondary levels.

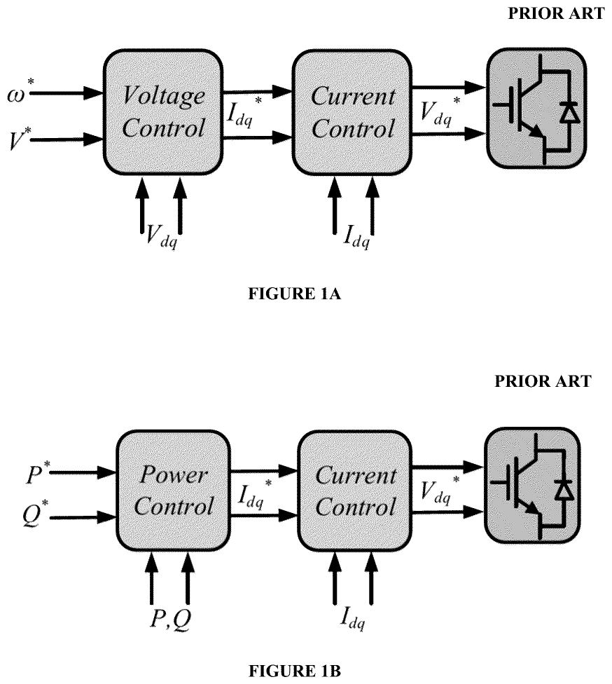

Primary Control Level. The primary control level in AC microgrids usually comprises the cascaded local controllers #for each DER, which based on their structure can operate in either grid following or the grid forming modes. The grid following converters are mainly in charge of regulating the locally generated active and reactive power values based on the received set points. However, the regulation task for the grid forming converters is focused on controlling the measured voltage and frequency values at the point of common coupling to make sure it is maintained within the permissible range. A general block diagram on the typical control architecture of these two modes of operation is shown in FIG. 1.

Grid following converters, such as that seen in FIG. 1(b), are structured with the power regulation loops along with inner current control loops. These current controllers regulate the current components in line with the calculated current setpoints received from the power controllers. As far as the grid forming topology is concerned, the outer control loop is assigned to the voltage and frequency regulation using the voltage controller while a current control loop is still utilized as the inner lop.

In the islanded AC microgrids, grid forming converters, such as that seen in FIG. 1(a), must be a part of the electrical network since their presence is critical for the system stability due to absence of utility grid connections. In fact, the grid forming converters operate in the master mode as opposed to grid following converters which always run in the slave mode. Grid forming converters do not need a synchronization to an external reference frame before connection to the PCC (i.e., the “point of common coupling”). The islanded microgrids can be configured as a network operated by either a single master or a multi master combination of DERs. A failure in any of the master grid forming converters can lead to malfunctions on the connected slave DERs. Therefore, in the preferred embodiment, the distributed control scheme has all DERs configured in the master mode of operation. Using this approach, the system reliability is enhanced and vulnerability of multiple DERs to a single point of failure is alleviated.

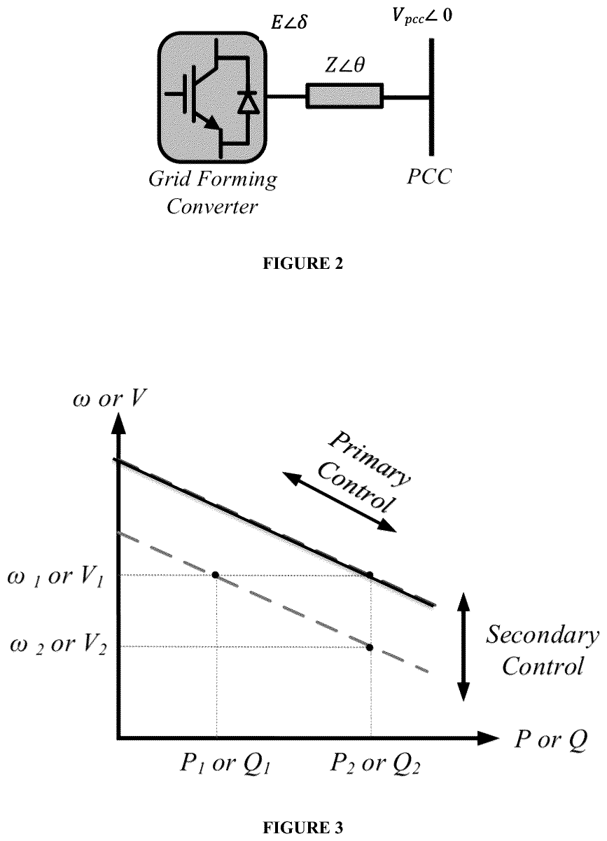

In the grid forming converters, the power sharing between DERs is controlled by the droop control method. Droop control is a technique for controlling synchronous generators and inverter-based resources, which allows multiple generation units to be connected in parallel and share loads in proportion to their power rating. Droop control for a grid forming converter can be explained based on the schematic shown in FIG. 2. Here, the high frequency harmonics and distortions are assumed to be negligible, and the generated voltage by the grid forming converter is represented in phasor mode with E<δ, while the generated current is denoted by I. The voltage at PCC is V_{pcc}<0 and the equivalent interconnection impedance value is represented by Z<θ. Equation (1) below calculates the apparent power exchange between the converter and the AC bus:

$$S = {V}_{pce} , {I}^{*} = \frac{{V}_{pcc} E ∠θ - δ}{Z} - \frac{{V}_{pcc}^{2} ∠ θ}{Z} \qquad ( 1 )$$

Following the above equation, the active power (P) and reactive power (Q) terms are derived by Equation (2) below:

$$\{ \begin{matrix}P = \frac{{V}_{pcc} E}{Z} cos ( θ - δ ) - \frac{{V}_{pcc}^{2}}{Z} cos ( θ ) \\ Q = \frac{{V}_{pcc} E}{Z} sin ( θ - δ ) - \frac{{V}_{pcc}^{2}}{Z} sin ( θ )\end{matrix} \qquad ( 2 )$$

For typical medium voltage power lines, the inductive term dominates line impedance. Therefore, active and reactive power terms can be simplified using Equation (3) below, assuming the angle θ is very close to 90 degrees.

$$\{ \begin{matrix}P = \frac{{V}_{pcc} E}{Z} sin ( δ ) \\ Q = \frac{{V}_{pcc} E cos ( δ ) - {V}_{pcc}^{2}}{Z}\end{matrix} \qquad ( 3 )$$

Since the power angle term δ is usually small, it is assumed that sin(δ)=δ and cos(δ)=1. Thus, the active power can be regulated by adjusting the frequency value, whereas the reactive power control is attainable through voltage amplitude regulation. The voltage and frequency in the primary level are determined using the setpoints and droop terms represented in Equation (4) below where ω and V represent the frequency and voltage, respectively, while ω* and V* are the respective references values for the frequency and voltage. Also, mₚ and m_{q} are droop terms for active and reactive power respectively.

$$\{ \begin{matrix}ω = {ω}^{*} - {m}_{p} P \\ V = {V}^{*} - {m}_{q} Q\end{matrix} \qquad ( 4 )$$

Secondary Control. The main control objective in the secondary layer is to compensate the deviations observed on the locally measured voltage value, and frequency value as the global variable. Also, a more accurate power sharing performance between the DERs in this control layer can be achieved. The power set points are usually assigned with respect to the DER rated power values. These normalized power terms are represented by P_{Ni}=(Pᵢ÷P_{rated,i}) and Q_{Ni}=(Qᵢ÷Q_{rated,i}) where Pᵢ, Qᵢ represents the instantaneous active and reactive power values for node i, respective. The voltage/frequency sharing as well as power sharing are accomplished by introducing extra regulatory terms into the local controllers as formulated in Equation (5) which gives an additional degree of freedom for the more desirable regulation of the local variables. The impact of primary and secondary regulatory terms is graphically demonstrated in FIG. 3. Thus, the local control setpoints are modified as follows where Δ_{ωsec}, ΔV_{sec} represent the secondary control terms for frequency and voltage, respectively.

$$\{ \begin{matrix}ω = {ω}^{*} - {m}_{p} P + {Δω}_{sec} \\ V = {V}^{*} - {m}_{q} Q + {ΔV}_{sec}\end{matrix} \qquad ( 5 )$$

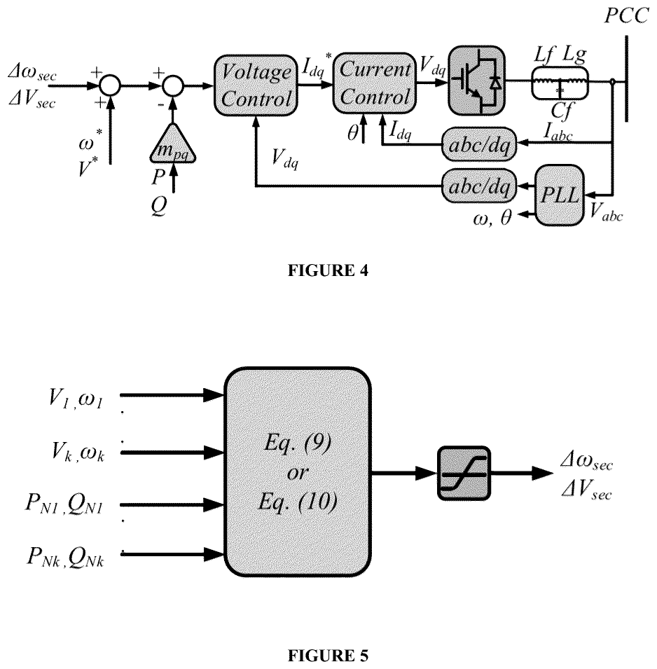

The detailed block diagram of the local controller for a grid forming converter in presence of the secondary layer regulation terms is depicted in FIG. 4. The conventional approach is based on the centralized scheme where a central computation unit oversaw calculating the secondary control terms through the communication with all DERs. In the distributed approach, the computations of secondary terms are performed at the place of each DER with respect to the data received from other DERs. Averaging and consensus-based control techniques are the most common types of distributed secondary controllers. In the averaging scheme, a strong interconnection topology is established between all existing nodes, while in consensus the communication only between the adjacent nodes are established in a way that a robust communication network in the secondary layer is ensured.

For a microgrid with n nodes, the adjacency matrix is of size n×m. The matrix elements (aᵢⱼ) are zero when there is no direct communication between nodes i and j, and aᵢⱼ>0 when there is data transfer between them. The adjacency matrix and the consensus-based update rule on variable x for node i can be represented by Equations (6) and (7), respectively.

$${A}_{n , n} = [ \begin{matrix}{a}_{1 , 1} & {a}_{1 , 2} & … & {a}_{1 , n} \\ {a}_{2 , 1} & {a}_{2 , 2} & … & {a}_{2 , n} \\ ⋮ & ⋮ & ⋱ & ⋮ \\ {a}_{n , 1} & {a}_{n , 2} & … & {a}_{n , n}\end{matrix} ] \qquad ( 6 )$$

$$\dot{{x}_{i}} = - {\sum }_{j = 1}^{n} {a}_{ij} ( {x}_{i} - {x}_{j} ) \qquad ( 7 )$$

This can also be reformulated as shown in Equation (8) where

$${w}_{ij} = \frac{{a}_{ij}}{{\sum }_{k = 1}^{n} a - ik} : \frac{1}{{\sum }_{j = 1}^{n} {a}_{ij}} \dot{{x}_{i}} = - {x}_{i} + {\sum }_{j = 1}^{n} {w}_{ij} {x}_{j} \qquad ( 8 )$$

Using the above adaptation law, the variable xᵢ on node i converges to the weighted average of its neighbor values xᵢⱼ with the time constant of

$${\sum }_{j = 1}^{n} {a}_{ij} .$$

The general block diagram of the conventional consensus-based secondary control scheme is depicted in FIG. 5. Using the general consensus law, the secondary control layer regulation set-point can be derived by Equation (9) and (10) for voltage/frequency sharing and power sharing, respectively:

$$\{ \begin{matrix}\dot{{ω}_{i}} = - ( {\sum }_{j = 1}^{n} {a}_{ij} ( {ω}_{i} - {ω}_{j} ) + {k}_{ω i} ( {ω}_{i} - {ω}_{ref} ) ) \\ \dot{{V}_{i}} = - ( {\sum }_{j = 1}^{n} {a}_{ij} ( {V}_{i} - {V}_{j} ) + {k}_{Vi} ( {V}_{i} - {V}_{ref} ) )\end{matrix} \qquad ( 9 )$$

$$\{ \begin{matrix}\dot{{P}_{Ni}} = - {\sum }_{j = 1}^{n} {a}_{ij} ( {P}_{Ni} - {P}_{Nj} ) \\ \dot{{Q}_{Ni}} = - {\sum }_{j = 1}^{n} {a}_{ij} ( {Q}_{Ni} - {Q}_{Nj} )\end{matrix} \qquad ( 10 )$$

Where k_{ωi} and k_{Vi} are the proportional control gains for regulation of the frequency ω and voltage V with respect to the reference values in the second layer, and by P_{N}=(P÷P_{rated}) and Q_{N}=(Q÷Q_{rated}) representing the normalized active and reactive power terms with respect to the rated power values for each node.

Impacts of Cyberattacks on Consensus Schemes. In this section, the impact of the cyberattacks on the conventional consensus-based voltage-frequency regulation scheme is analytically discussed. Considering the presence of a non-cooperative node k, which transmits a corrupted data frame to node m, while the data integrity over the rest of communication links and associated data packets are maintained, the consensus equation for node m can be represented by Equation (11).

$$\{ \begin{matrix}\dot{{ω}_{m}} = - ( {\sum }_{j = 1}^{n} {a}_{mj} ( {ω}_{m} - {ω}_{j} ) + {k}_{ω m} ( {ω}_{m} - {ω}_{ref} ) - {a}_{mk} {Δω}_{mk} ) \\ \dot{{V}_{m}} = - ( {\sum }_{j = 1}^{n} {a}_{mj} ( {V}_{m} - {V}_{j} ) + {k}_{Vm} ( {V}_{m} - {V}_{ref} ) - {a}_{mk} {ΔV}_{mk} )\end{matrix} \qquad ( 11 )$$

Where ωₘ and Vₘ are the frequency and voltage terms at the place of the node m, aₘⱼ and aₘₖ represent the neighboring coefficients for the communication link between nodes m-j and m-k on the adjacency matrix, k_{ωm} and k_{Vm} are proportional control gains for regulation of the ω and V at the place of the node m with respect to the reference values, and Δ_{ωmk} and ΔVₘₖ denote the cyber intrusion terms for frequency and voltage distributed signals sent from node k to node m and generated only as a result of external manipulation.

Thus, the secondary control terms in (5) for node m will initially change in proportion with the cyber intrusion terms:

$$\{ \begin{matrix}{Δω}_{msec} \approx {K}_{m ω 1} {Δω}_{mk} \\ {ΔV}_{msec} \approx {K}_{mV 1} {ΔV}_{mk}\end{matrix} \qquad ( 12 )$$

Where kₘᵥ₁ and k_{mV1} are the proportional gains to deviations on secondary regulation terms for frequency and voltage at the place of node m as generated directly by external manipulations, respectively.

Because frequency is the global variable, such an intrusion will proportionally impact the global frequency ω_{global}. Therefore, this impact will be reflected for all the nodes within the term (wᵢ−w_{ref}) in (9) and (wₘ−w_{ref}) in Equation (11) where the wᵢ and wₘ are impacted with the variations on the w_{global} introduced by Δwₘₖ and resulting in minor attenuation contribution to secondary regulation terms for nodes indexed by m and i, as represented in Equations (13) and (14).

$${Δω}_{msec} \approx - {K}_{m ω 2} {Δω}_{mk} \qquad ( 13 )$$

$${Δω}_{isec} \approx - {K}_{i ω 2} {Δω}_{mk} \qquad ( 14 )$$

Where k_{mV2} and k_{iw2} are the proportional gains to deviations on secondary regulation terms for frequency on nodes m and i as the indirect impact of cyber intrusion respectively.

Since the direct impact of cyberattacks on the global frequency is always further attenuated by means of other cooperative nodes (indirect impact), the significance of the neighboring error term (wₘ-wⱼ) always outweighs the local error term (wₘ-w_{ref}) in Equation (11) and therefore the following for the node m will be justified:

$${k}_{m ω 1} ≫ {k}_{m ω 2} \qquad ( 15 )$$

Thus, the overall resultant impact of such an intrusion on the frequency terms in the secondary control layer for the nodes indexed by m and i can be formulated as follows:

$${Δω}_{msec} \approx ( {K}_{m ω 1} - {K}_{m ω 2} ) {Δω}_{mk} , \\ where {K}_{m ω 1} ≫ {K}_{m ω 2} > 0 \qquad ( 16 )$$

$${Δω}_{isec} \approx - {K}_{i ω 2} {Δω}_{mk} , where {K}_{i ω 2} > 0 \qquad ( 17 )$$

As a result, the aggregated direct and indirect impacts of such a cyber-intrusion on nodes m and i can be summarized as follows:

$$\{ \begin{matrix}{Δω}_{msec} > 0 and {Δω}_{isec} < 0 for {Δω}_{mk} > 0 \\ {Δω}_{msec} < 0 and {Δω}_{isec} < 0 for {Δω}_{mk} < 0\end{matrix} \qquad ( 18 )$$

The impact on the global frequency is dominated by the term Δw_{msec} while some attenuation through Δw_{isec} is introduced. However, it should be noted that the deviations introduced into the secondary control terms will also lead to proportional deviations in the active powers. In the case of the islanded AC microgrids, the overall drawn active power is dictated by the microgrid loading condition. However, the incompatibility of frequency deviations generated by cyber-attacks and power regulatory terms as imposed by loading condition hinders the microgrid reaching the equilibrium point and drives the converters toward overloading or shut-down conditions, thereby leading to system instability.

The impact of such intrusion on the voltage sharing scheme is less detrimental as the voltage is a local variable measured at the PCC of each DER. Beside the direct impact of corrupted voltage terms on the secondary control regulation for the node m as represented by Equation (12), the indirect impact on both m and i indexed nodes can be given by Equations (19) and (20). In contrast with the indirect impacts on the frequency secondary term for node i as represented by Equation (14), an additional error-following term (k_{iV3}ΔVₘₖ) is introduced which results from errors observed on adjacent voltage terms of (Vⱼ-Vᵢ):

$${ΔV}_{msec} \approx - {K}_{mV 2} {ΔV}_{mk} \qquad ( 19 )$$

$${ΔV}_{isec} \approx - {K}_{iV 2} {ΔV}_{mk} + {K}_{iV 3} {ΔV}_{mk} \qquad ( 20 )$$

Where k_{mV2}, k_{iV2} and k_{iV 3} are the proportional gains to deviations on secondary regulation terms for voltage on nodes m and i as the indirect impact of cyber intrusion, respectively.

Thus, the overall resultant impact of such an intrusion on the voltage terms in the secondary control layer for the nodes indexed by m and i can be described through the following equations:

$${ΔV}_{msec} \approx ( {K}_{mV 1} - {K}_{mV 2} ) {ΔV}_{mk} , , \\ where {K}_{mV 1} ≫ {K}_{mV 2} > 0 \qquad ( 21 )$$

$${ΔV}_{isec} \approx ( - {K}_{iV 2} + {K}_{iV 3} ) {ΔV}_{mk} , where {K}_{iV 2} > 0 \qquad ( 22 )$$

In comparison with Equation (17), in Equation (22) an additional contributing term as an indirect impact of cyber intrusion is introduced into voltage secondary control terms for the nodes indexed by i which gives an additional degree of freedom to reach the equilibrium point without driving the system into the unstable condition. It should be also added that the reactive power sharing will also be deviated based on the ΔV_{msec} and ΔV_{isec} at the equilibrium point.

Cyber-Resilient Sliding Mode Consensus Control. The sliding mode control strategy is formed based on driving the system states toward the desired manifolds using the chosen discontinuous control signals. The proper selection of the sliding surfaces must ensure the proper regulation performance while the states converge toward the specified manifolds. Referring to the Equations (9) and (10) and the known relationship between the P-w and Q-V over the inductive power lines from Equations (3) and (4), the secondary layer frequency and voltage dependent control objectives are summarized by Equations (23)-(25) and (26)-(28), respectively:

$${Δω}_{ω i} = {ω}_{ref} - {ω}_{i} \qquad ( 23 )$$

$$Δ {ω}_{ω ij} = {\sum }_{j = 1}^{n} {a}_{ω ij} ( {ω}_{j} - {ω}_{i} ) \qquad ( 24 )$$

$$Δ {ω}_{Pij} = {\sum }_{j = 1}^{n} {a}_{Pij} ( {P}_{Nj} - {P}_{Ni} ) \qquad ( 25 )$$

$${ΔV}_{vi} = {V}_{ref} - {V}_{i} \qquad ( 26 )$$

$${ΔV}_{vij} = {\sum }_{j = 1}^{n} {a}_{vij} ( {V}_{j} - {V}_{i} ) \qquad ( 27 )$$

$${ΔV}_{Qij} = {\sum }_{j = 1}^{n} {a}_{Qij} ( {Q}_{Nj} - {Q}_{Ni} ) \qquad ( 28 )$$

Where Δω_{ωi}, Δω_{ωij}, ΔωP_{ωi} denote the frequency error terms for the agent i with respect to reference frequency value, adjacent neighboring frequency terms, and adjacent neighboring active power terms, respectively. Moreover, ΔVᵥᵢ, ΔVᵥᵢⱼ, ΔV_{Qij} represent the voltage error terms for the agent i with respect to reference voltage value, adjacent neighboring voltage terms, and adjacent neighboring reactive power terms. Parameters α_{ωij}, αᵥᵢⱼ, α_{Pij}, α_{Qij} are the adjacency coefficients for the frequency, voltage, active power and reactive power of node i with respect to the neighbor nodes as indexed by j.

To ensure the proper secondary layer regulation over the desired variables of the agent i with respect to the reference value and the adjacent neighboring terms, the sliding surfaces are chosen by Equations (29)-(34). As stated by Equations (29) and (32), the selected surfaces consist of two complementary terms. The first term, as formulated by Equations (30) and (33), uses first order dynamics to ensure convergence to the reference values and minimizing the error terms. However, due to the previously known trade-off behavior between the P-F and Q-V terms as depicted in FIG. 3, it is impossible to have the first terms in Equations (29) and (32) equal to zero at any instant. This is mainly attributed to the fact that prioritizing the error minimization on Δω_{ωij} and ΔVᵥᵢⱼ will result in larger offsets on Δω_{Pij} and ΔV_{Qij}, respectively and vice versa. This issue has not yet been considered in sliding mode based secondary layer control schemes known in the art.

To mitigate this shortcoming, a compensation term for each surface is introduced in this paper which counteracts the introduced offsets based on the applied flexible adjustments. The main advantage of this term is the more effective and straight forward selection of the boundary layer threshold (represented by Equation (38)) and avoiding the excessive chattering effects attributed to the sliding switching function under some specific operating conditions. To alleviate the impact of cyber invasions on the novel SMC scheme and avoid excessive deviations from the manifolds once the cyberattacks occur, an attenuating exponential factor is applied to the second term in the surface formulations which is a function of neighboring frequency and voltage error terms. Without this exponential term, the sliding surface will be highly vulnerable to the cyber-attacks and only remains effective during the normal operating condition while there is no non-cooperative node. In fact, the second term in sliding surfaces cancels the offsets during the normal operating condition while being automatically filtered out upon detecting the excessive levels of cyber errors.

$${S}_{ω} = {S}_{ω 1} + {S}_{ω 2} \qquad ( 29 )$$

$${S}_{ω 1} = Δ {ω}_{ω i} + Δ {ω}_{ω ij} + Δ {ω}_{Pij} + {c}_{ω 1} ( \frac{d}{dt} Δ {ω}_{ω i} + \frac{d}{dt} Δ {ω}_{ω ij} + \frac{d}{dt} Δ {ω}_{Pij} ) \qquad ( 30 )$$

$${S}_{ω 2} = {K}_{Pij} , {e}^{- {K}_{ω exp} \vert Δ {ω}_{ω ij} \vert} , Δ {ω}_{ω ij} \qquad ( 31 )$$

$${S}_{v} = {S}_{v 1} + {S}_{v 2} \qquad ( 32 )$$

$${S}_{v 1} = {ΔV}_{vi} + {ΔV}_{vij} + {ΔV}_{Qij} + {c}_{v 1} ( \frac{d}{dt} {ΔV}_{vi} + \frac{d}{dt} {ΔV}_{vij} + \frac{d}{dt} {ΔV}_{Qij} ) \qquad ( 33 )$$

$${S}_{v 2} = {K}_{Qij} , {e}^{- {K}_{ω exp} \vert Δ {V}_{vij} \vert} , {ΔV}_{vij} \qquad ( 34 )$$

Where S_{ω}, Sᵥ denote the overall selected sliding surface, S_{ω1}, Sᵥ₁ represent the first sliding surface term, and S_{ω2}, Sᵥ₂ are the second sliding surface term for the secondary layer sliding mode consensus control of frequency and voltage terms, respectively. The c_{ω1} and cᵥ₁ constants also denote the corresponding design constant gains for the chosen sliding surfaces and the K_{Pij} and K_{Qij} constants represent the offset compensation gains for addressing the surface deviations introduced by active and reactive power terms. In addition, K_{ωexp}, Kᵥₑₓₚ are the decaying rate constants for counteracting the adverse impact of cyber intrusions on the selected frequency and voltage terms for the sliding surface in the secondary control layer.

As the next step, it is necessary to ensure the convergence of the state variables towards the sliding surfaces and retaining it over the surfaces during the steady state condition. The regulation goals can be achieved when S_{ω}=Sᵥ=0. By applying this to the Equations (29)-(34), the following equations are obtained:

$$\frac{d}{dt} ( {Δω}_{ω i} + {Δω}_{ω ij} + {Δω}_{Pij} ) = - \frac{1}{{c}_{ω 1}} ( {Δω}_{ω i} + {Δω}_{ω ij} + {Δω}_{Pij} + {K}_{Pij} . {e}^{- {K}_{ω exp} \vert {Δω}_{ω ij} \vert} , Δ {ω}_{ω ij} ) \qquad ( 35 )$$

$$\frac{d}{dt} ( {ΔV}_{vi} + {ΔV}_{vij} + {ΔV}_{Qij} ) = - \frac{1}{{c}_{v 1}} ( {ΔV}_{vi} + {ΔV}_{vij} + {ΔV}_{Qij} + {K}_{Qij} . {e}^{- {K}_{vexp} \vert Δ {V}_{vij} \vert} , {ΔV}_{vij} ) \qquad ( 36 )$$

As previously discussed, the inherent offset values for Δω_{Pij} and ΔV_{Qij} will be cancelled out by S_{ω2} and Sᵥ₂ terms under the normal operating condition while these compensation terms are automatically equaled to zero under the excessive levels of cyber-attacks. Therefore, it is realized from Equations (35) and (36) that the state variables converge to the specified surfaces for any positive values selected for the constant control gains of c_{ω1}, cᵥ₁. In this scheme, the constant control gains act as the low pass filters and thus the gains are selected with respect to the desired transient performance.

As the next step, it is required to enforce the sliding mode operation over the specified manifolds using the discontinuous control signals. For this purpose, the sgn(·) function is used where higher sliding mode gain values of K_{smc} in Equation (37) oversee enhancing the controller robustness.

$$Δ {x}_{isec} = {K}_{smc} sgn ( {S}_{k} ) \qquad ( 37 )$$

Where Δx_{isec} denotes either the voltage or frequency secondary control term for the node i as presented by Equation (5).

However, the improper high SMC gain values can lead to the excessive chattering due to the discontinuous nature of the applied control signals and this can potentially excite some un-modeled dynamics. To mitigate this problem, the pure sgn(·) function is replaced with a continuous control function within the specified boundary layer of the sliding surface as represented by:

$${Sgn}_{cont} ( {S}_{k} ) = \{ \begin{matrix}1 , & if {S}_{k} > {ε}_{k} \\ \frac{{S}_{k}}{{ϵ}_{k}} , & if \vert {S}_{k} \vert < {ε}_{k} \\ - 1 , & if {S}_{k} < {ε}_{k}\end{matrix} \qquad ( 38 )$$

Where k denotes the index for the sliding surfaces and εₖ>0 represents the boundary layer threshold as well as functioning as a smoothing factor for transition between the two schemes. Sgn_{cont}(·) is also the continuous form of Sgn(·) function.

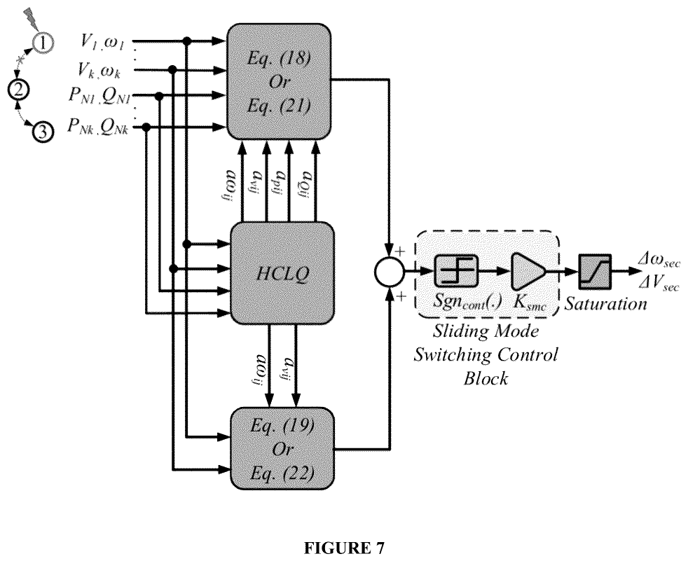

The block diagram for the proposed sliding mode consensus based secondary control scheme is depicted in FIG. 7. One embodiment of the proposed secondary control scheme comprises an intrusion impact module and an aggregate impact module. To enable a more realistic tuning approach for the SMC controllers, it is essential to ensure that the deviation levels in the distributed sharing terms are retained bounded to specific levels. Extreme erroneous terms would demand much higher controller gain values and this would adversely impact the steady state performance of the secondary SMC controller. To address this concern, a hysteresis-based communication link quality (HCLQ) observer is introduced to the secondary control scheme. The HCLQ receives inputs of voltage or frequency and active power or reactive power.

The intrusion impact module applies either Equation 19 or Equation 22 depending on whether the input is frequency or voltage. The aggregate impact control module receives inputs from a DER of either voltage or frequency and active power or reactive power, as well as adjacency coefficients for the frequency, voltage, active power and reactive power of node i with respect to the neighbor nodes as indexed by j from the HCLQ. Depending on the type of inputs received, the aggregate impact module applies either Equation 18 or Equation 21.

The outputs of the aggregate impact module and intrusion impact module #are then summed by an adder. The output of the adder is inputted into the sliding mode switching control block, comprising an sgn(·) function and sliding mode controller constant. The output of the sliding mode switching control block is applied to a step-up function, which produces the change in voltage or frequency for the particular DER.

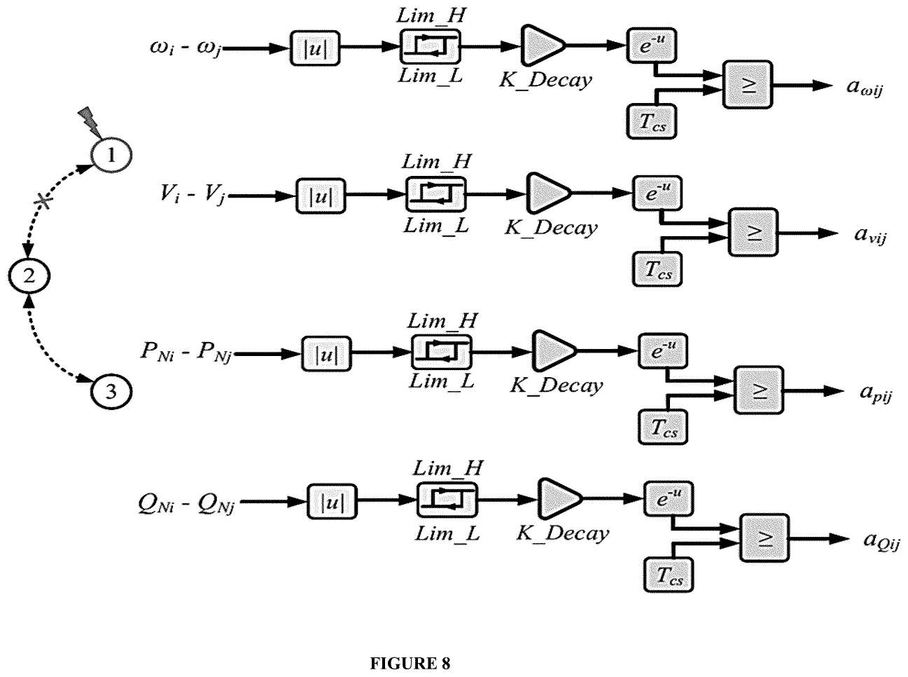

The components of the HCLQ observer are detailed in FIG. 8. This observer monitors the deviation levels in the distributed terms and uses the hysteresis upper bound level to trigger a one-shot decaying logarithmic function for isolating the non-cooperative node. To avoid frequent node partial isolations on common disturbances, a specified threshold on the decaying logarithmic output is utilized for immediate disconnection after certain timing interval from the exceeded error level in the adjacent distributed terms. The logarithmic delay unit is reset once the distributed term errors retrieve to a level lower than hysteresis lower bound value.

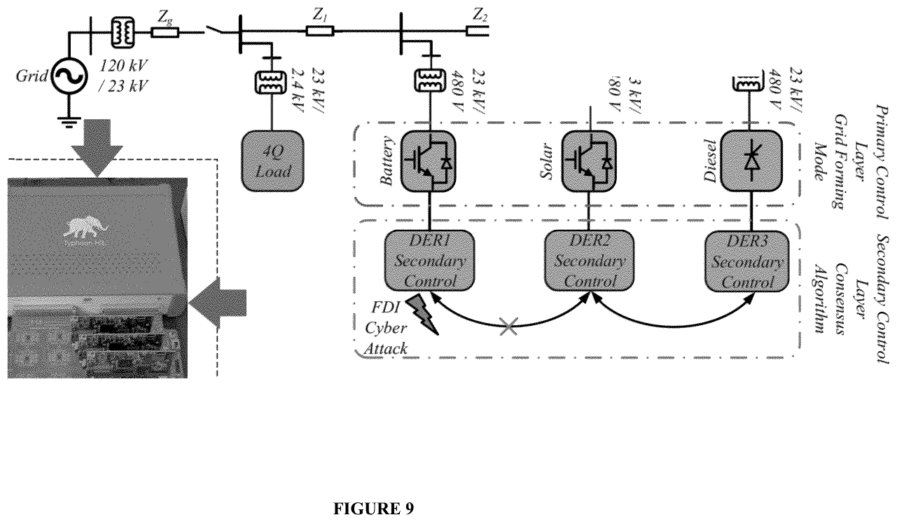

Real Time Simulation Results. To evaluate the performance and effectiveness of the disclosed control system under common types of cyber-attacks, a microgrid topology consisting of three integrated DERs as shown in FIG. 9 was tested. The simulation model for this configuration was deployed in a real time simulator, incorporating both a combination of low inertia DERs (Solar and Battery) and a high inertia DER (Diesel) in this case study. This provides a more realistic insight into the system dynamic behaviors under such malicious attacks, and eliminates the adverse impacts attributed to erroneous assumption of having uniforms inertia DERs integrated into such an islanded AC microgrid topology.

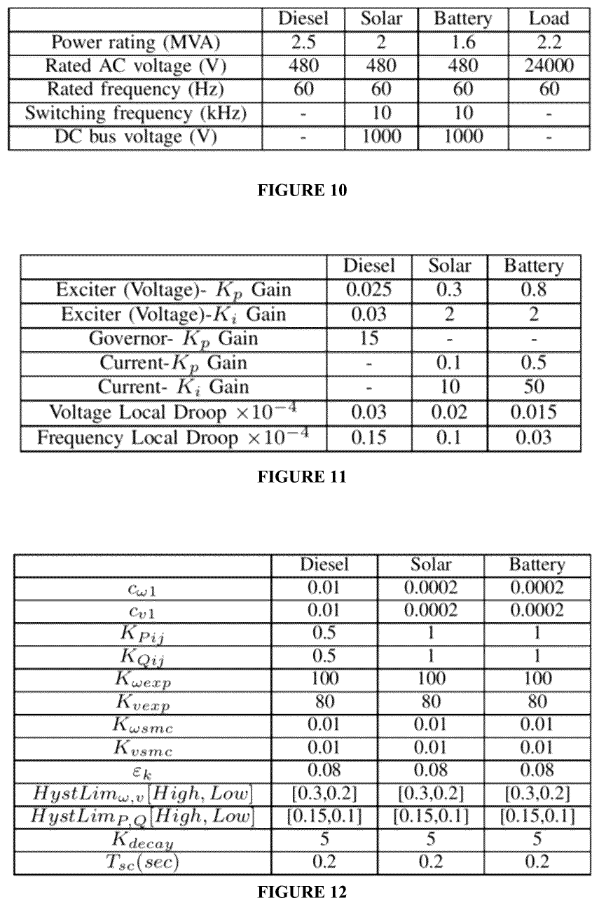

The electrical specifications for DERs and the four-quadrant load are given in FIG. 10. Modeling of all the DERs was performed in a high level of detail where the local controllers for the low inertia DERs constitute the cascaded voltage-current regulation loops as previously depicted in FIG. 4, and the excitation unit and governor control are used for controlling the local variables of voltage and frequency for the Diesel unit. In addition, the local controllers were equipped with the local droop terms. In the secondary control layer, two different control schemes were modeled and investigated. In the first scheme, the conventional consensus-based voltage-frequency sharing algorithm is applied based on the equations provided in Equation (9), where the adjacency communication matrices are set in a way that the direct communication between the Diesel and Battery nodes are disabled. While maintaining the same communication graph topology, the proposed sliding mode consensus-based scheme is also applied in the secondary layer to compare the attainable performance and resilience improvements. The local and secondary control parameters for all three DERs are given in FIG. 11 and Table FIG. 12. The distributed control performance was then comparatively studied for these two schemes by demonstrating the detrimental effects of minor FDI attacks on the conventional consensus scheme (where similar results are reported in other studies using a modified cascaded consensus control).

The improved robustness and resilience of the proposed scheme even after introducing more severe FDI attacks were also verified. For all the following scenarios, the FDI point of impact was restricted to the data communication packet delivered to the solar node from the battery node. To simulate the FDI attacks, the actual transmitted data word from the battery node was manipulated by offsetting the corrupted term with specified percentage levels with respect to its actual value. In all these cases, the microgrid operated in the islanded mode of operation from the time t=0. The resistance and inductance values of lines are 0.4 Q/km and 4 mH/km. The length of lines for Z₁, Z₂ and Z₃ connections were 3 km, 2 km, and 4 km, respectively. The grid impedance Z_{g} was also adjusted with 0.1 Q/km and 2 mH/km.

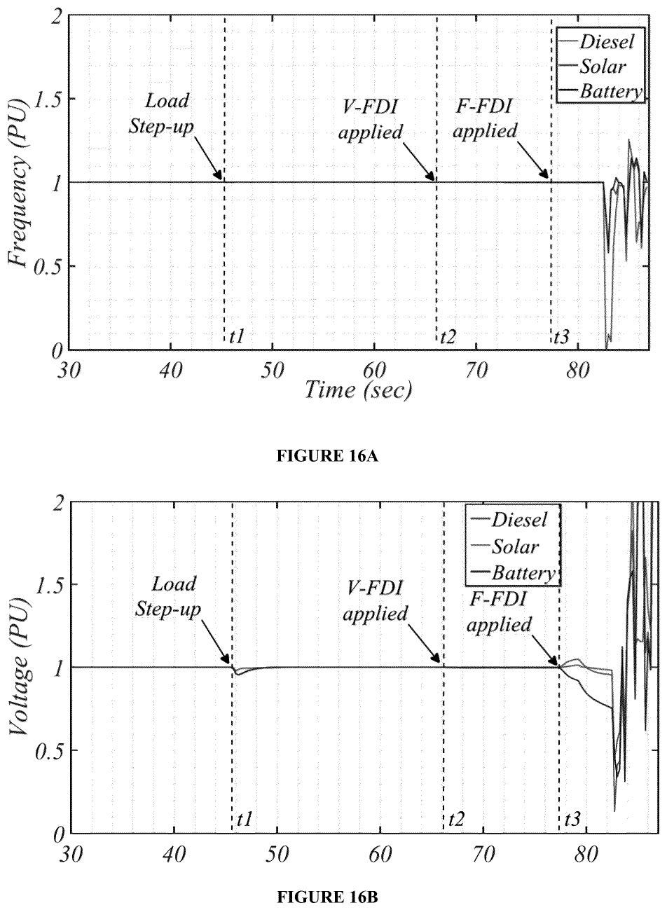

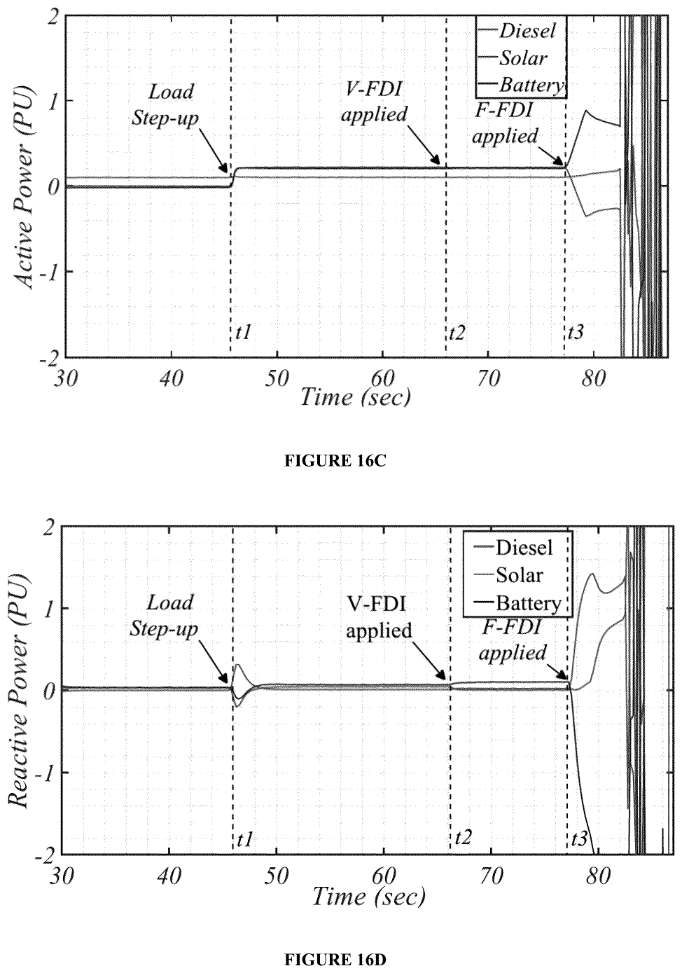

Case A: Conventional consensus under minor FDI attack. This case studies the impact of minor false data injection attacks on the conventional consensus secondary control scheme. The voltage, frequency, active power and reactive power sharing performance of the conventional consensus scheme under this scenario are shown in FIG. 16(A)-(D). In this case, the secondary controller was initially active, and then a load step from 200 kW to 1000 kW was applied at t=t₁. It is observed that the secondary algorithm ensures proper retrieving of frequency term, where for diesel node it takes about 0.5 seconds while for low inertia nodes it is resumed within 1.8 seconds. This performance is mainly attributed to the gain tuning applied to low inertia nodes to avoid excessive undershoots on the frequency signal. At t=t₂, a 2% FDI voltage signal manipulation was applied where the impact on reactive power sharing is reflected by about 0.04 PU power shift between the battery and solar nodes. Recalling the expected impacts of voltage FDI attack on the conventional consensus as stated in Equations (21) and (22), the equilibrium point is reached, and the voltage state variable does not diverge upon maintaining this bounded level of voltage cyber intrusion. However, when the same 2% drift was applied on the frequency term, the introduced offset drove the system state variables toward the unstable condition, which confirms the presented discussion on frequency FDIs and the expected impacts as represented by Equations (16) and (17). It is observed that the proper power control over all three nodes was lost as the power state variables were driven toward the overload condition and resulted in bus voltage deviations and loss of frequency synchronization. This can result in tripping the protective circuit breakers, but to better demonstrate the consequent impacts of such intrusions, the disconnection from the PCC upon overload condition was avoided. Therefore, the microgrid unstable condition is resulted, which is depicted with extreme fluctuation levels on the state variables.

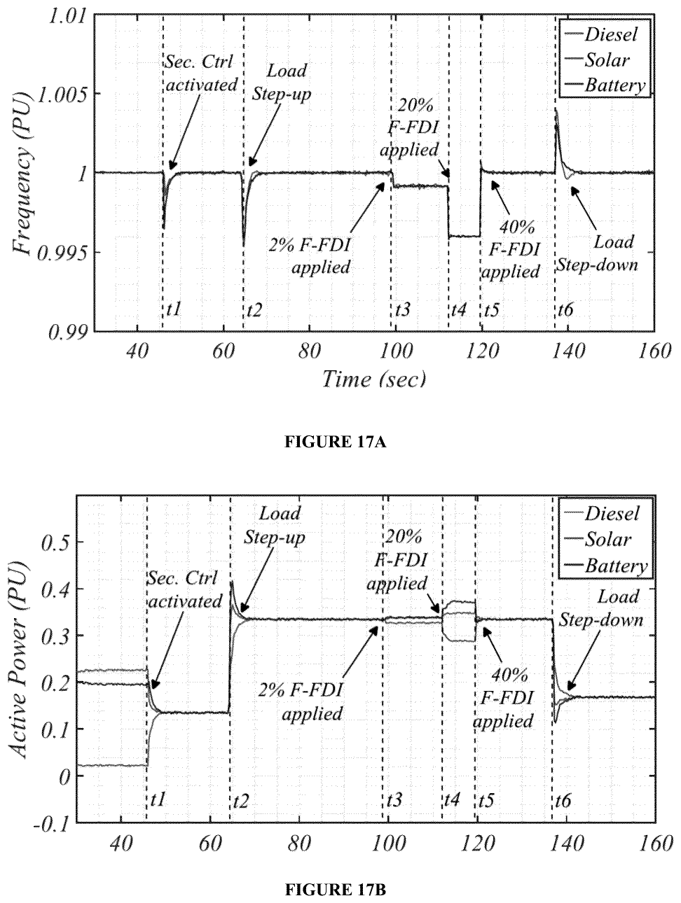

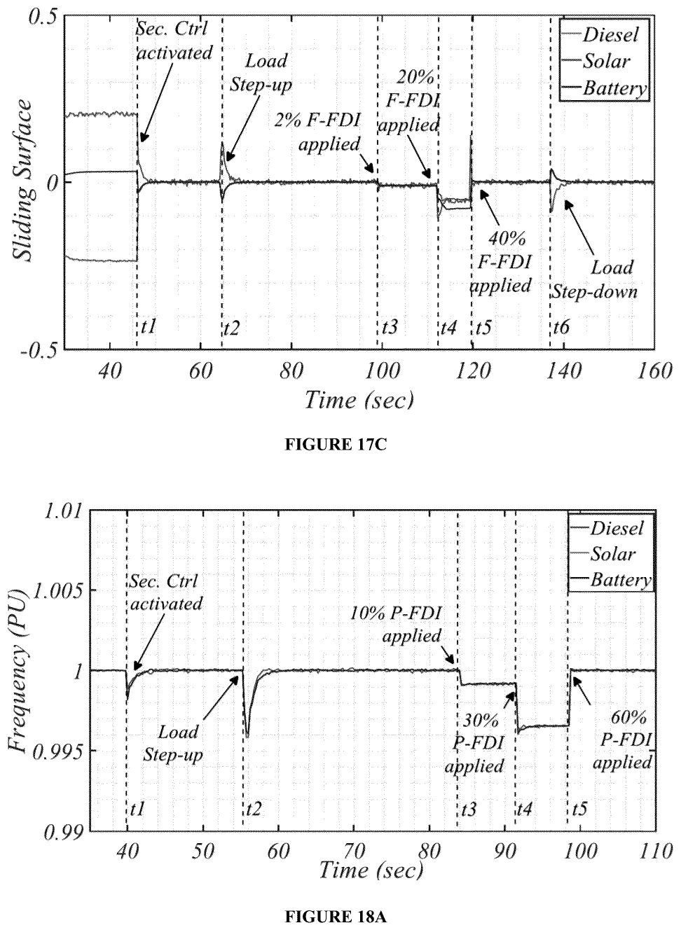

Case B: SMC consensus under different levels of frequency-FDI attacks. In this scenario, the impacts of frequency FDI attacks on the proposed sliding mode consensus-based scheme were investigated. The frequency, active power and the frequency sliding surface (S_{ω}) terms for all three DERs are depicted in FIG. 17(A)-(C). While the microgrid DERs are initially regulated using only the local controllers, the secondary control scheme is activated at t=t₁. It is observed that the normalized active power terms converge smoothly to the consensus value of 0.135 PU within 4 seconds, which resulted in quick frequency retrieving after undershooting by less than 0.35%. The sliding surface has also properly converged to zero within this interval. An active power load step change was applied at t=t₂, which resulted in the proper convergence of the normalized power terms in less than 4 seconds. The diesel active power signal shows a more sluggish response leading to an overshoot on the other two DERs power terms, as they must compensate for the introduced power shortage during the transient condition. Moreover, the quick convergence of sliding surfaces has enabled the negligible frequency to undershoot of less than 0.5%. The disturbance rejection performance of the SMC was tuned through a trade-off between the sliding mode control gains and the boundary layer thresholds. The higher control gain values ensure a quicker convergence but may also lead to excessive chattering on the steady state mode. By extending the boundary layer zone, the chattering effect was alleviated. At t=t₃, the FDI attack level of 2% (same as case 1) was applied on the frequency term which has only resulted in 0.1% frequency drift without causing the microgrid instability. Recalling the Case A, introducing 2 percent frequency FDI attack resulted in the total microgrid instability within less than 5 seconds, but the scheme disclosed herein shows a robust performance even after much longer duration. This is mainly attributed to the enhanced SMC robustness to external disturbances, uncertainties, and improved power sharing dynamics. At t=t₄, the FDI attack was increased to 20% drift in the frequency signal, and again it was observed that the system remained resilient to the applied disturbance and only 0.4% frequency drift is produced. By increasing the FDI intrusion level to the 40% at t=t₃, the HCLQ detected the non-cooperative communication node and isolated it from the secondary control configuration. In this case, the frequency drift was recovered within less than 0.1 sec due to the quick isolation of the adjacency term by the HCLQ. This also ensures that the applied disturbance to the shared secondary signals never violates the bounded levels and the SMC stable operation is guaranteed. A load step down was applied at t=t₆ which shows that the proper power sharing performance is still maintained.

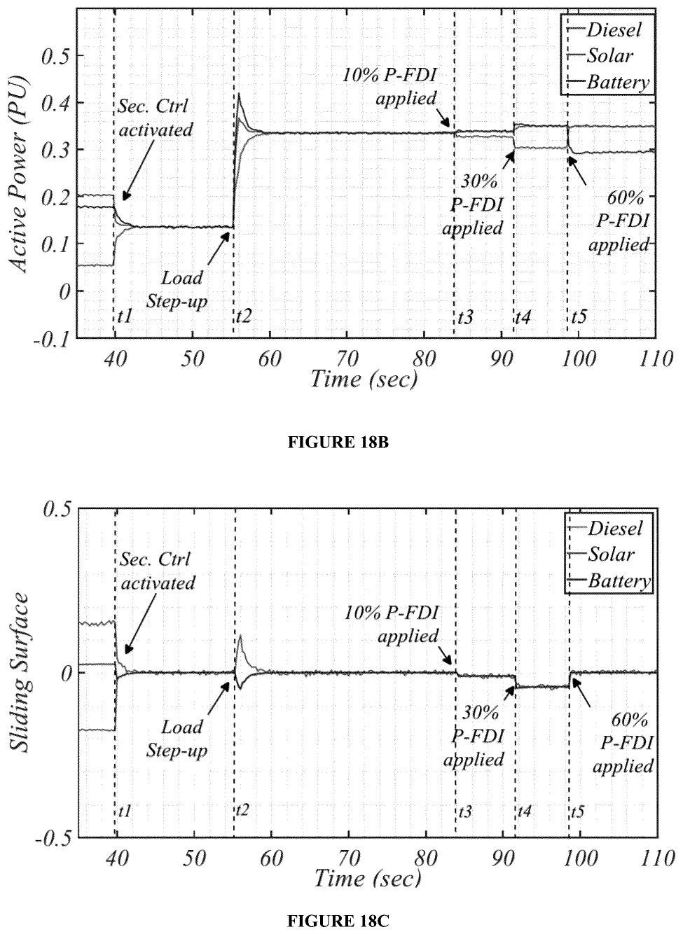

Case C: Disclosed SMC consensus under different levels of active power-FDI attack. The frequency, active power, and frequency sliding surface S_{ω} terms for all three DERs are depicted in FIG. 18(A)-(C). In this case, the same sequence of actions as presented in Case B was applied at t₁ and t₂, where the sliding mode consensus scheme is activated at t₁ and then the same load step change is applied on t₂. A 10% FDI drift on the active power term is applied at t₃, which resulted in 0.1% frequency deviation. This is due to the phenomenon that introduced deviations on the distributed power terms produce a negative offset value on the secondary frequency actuation terms, which leads to the global frequency deviation. Having differently distorted secondary frequency terms along with new global frequency value resulted in different offset values on the DERs' power terms in the grid forming operation mode. At 14, the FDI level increased by 30%, and about 0.35% frequency deviation was observed. By increasing the FDI level to 60% at t₅, the corrupted signal term from the non-cooperative node was detected by HCLQ module and the non-cooperative node was isolated. Using this approach ensures that the cyber intrusions are restricted to the bounded levels, which guarantees stable SMC operating condition. Having the non-cooperative node isolated, the frequency was retrieved within less than 150 ms. The active power graph shows that the deviation was mainly imposed on the solar power term as it encountered receiving corrupted shared signals from its neighbor node (Battery node). After detection of the FDI attack and isolating the battery distributed power term, the battery started operating in the decentralized mode based on its local droop term, while the remaining level of power was properly shared between the two nodes of solar and diesel.

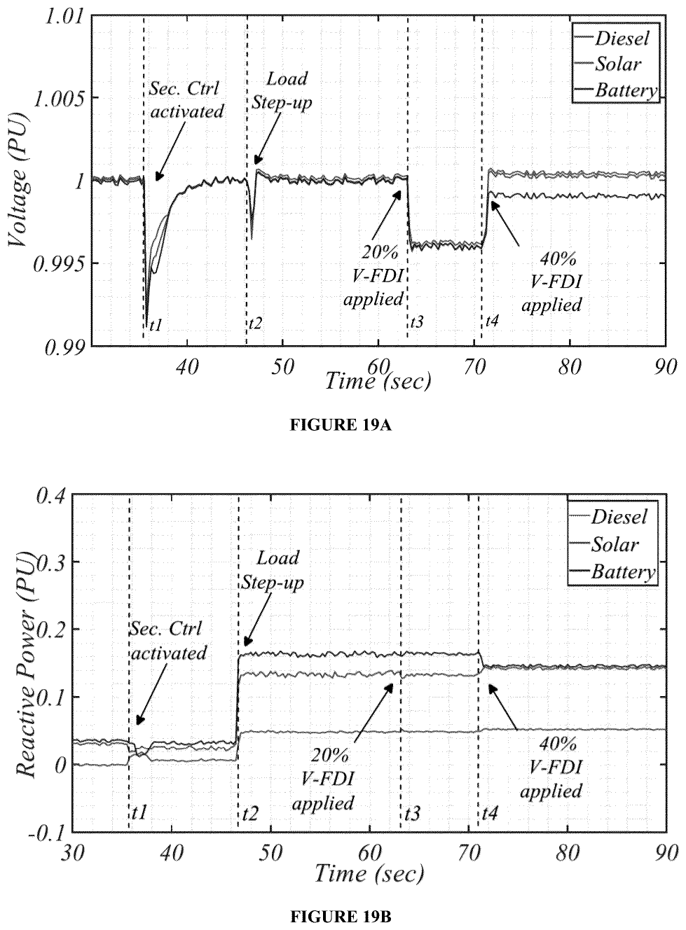

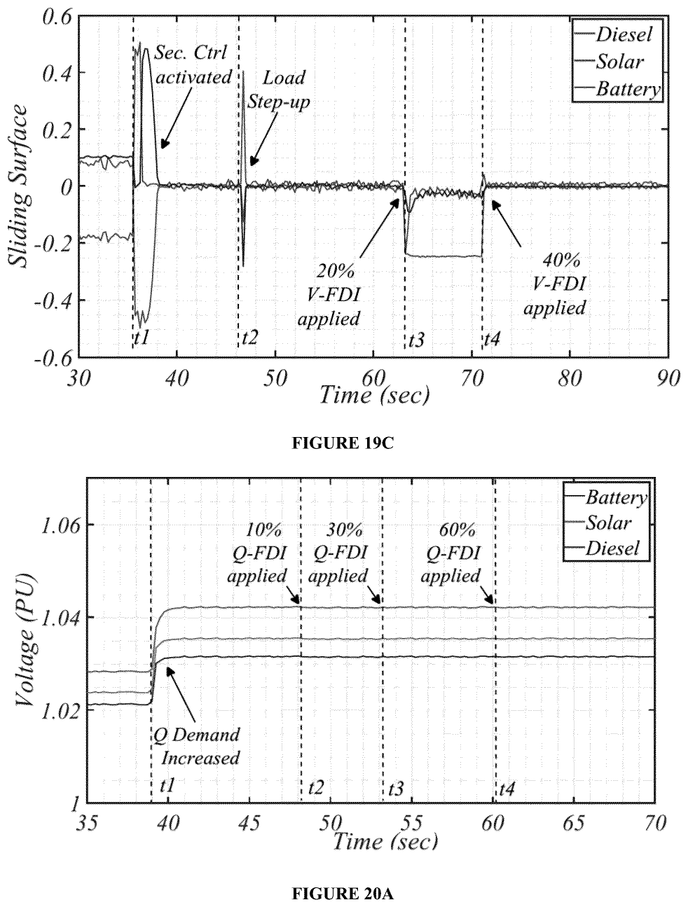

Case D: Disclosed SMC consensus under different levels of voltage-FDI attack. The effectiveness of the scheme disclosed herein was also studied under the presence of voltage FDI attacks. The voltage sharing performance for each DER along with the reactive power sharing performance and the sliding surface for the voltage term regulation are depicted in FIG. 19(A)-(C). For regulation of the V-Q sharing performance, a trade-off adjustment with a priority given to the voltage regulation was applied. At t₁, the proposed secondary controller was enabled, and it was observed that the sliding surface was converged within less than 5 seconds, while the voltage undershoot was less than 0.9%. A quicker convergence is also attainable at the expense of larger voltage transient undershoot peaks by increasing the sliding mode control gains. At t₂, the reactive load stepped up to 600 kV ar. It was observed that the sliding surface effectively handles the applied disturbance within about 1 second and the voltage deviation was retrieved within about 2 seconds, where only a 0.3% voltage deviation was observed on the transient period. Having adjustable adaptive regulatory parameters for distributed voltage and reactive power terms within the sliding surface mathematical representation provides flexibility for the convergence rate tuning.

A 20% voltage FDI attack was applied at t₃, which only resulted in 0.4% voltage deviation at PCCs, and the sliding surfaces on battery and diesel have been retrieved in 1.5 seconds and the solar surface deviation has been maintained in an acceptable level as the generated output voltage levels were not deteriorated. By increasing the FDI intrusion level on voltage to 40%, the HCLQ detected and isolated the non-cooperative node. As a result, the voltage deviations for solar and diesel node were restored while the battery is operating in decentralized mode.

Case E: SMC consensus under different levels of reactive power-FDI attack in the grid following mode. From the previously stated discussions and test scenarios, it is known that the role of cyber-resilient consensus control algorithms in the grid forming mode is more critical due to the system vulnerability to the minor F-FDI attacks. However, it was beneficial to also investigate the effectiveness of the proposed SMC-consensus algorithm in the grid following operation mode to ensure its versatility. Since frequency in such a grid-tied microgrid is dominated by the infinite electric bus, the V-Q sharing is only considered where the priority is given to the Q sharing task.

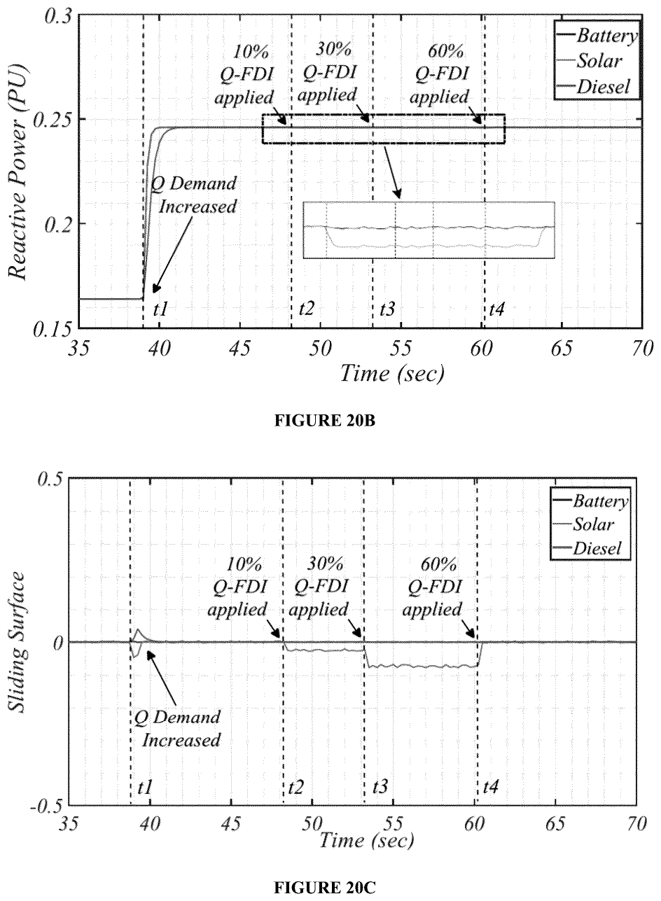

The reactive power sharing performance, bus voltage levels, and the sliding surface for the Q-sharing algorithm in the grid following mode are also evaluated and shown in FIG. 20(A)-(C). In this investigation, the Q sharing between the nodes was initially enabled, and due to priority given to the reactive power sharing, the sliding surface compensation term in Equation (34) was fed by the ΔV_{Qij} instead of ΔVᵥᵢⱼ and the same gain values maintained. In the grid following mode of operation, it is required for DERs to follow the dispatched Q-setpoint values received and ensure a power sharing on the transients. Due to availability of local P-Q regulation blocks, the dispatched setpoint values was added with the distributed SMC term to be fed to the local power regulators. The initial reactive power setpoint of 1000 kVar was equally dispatched to the three nodes, where at t=t1 the setpoint was raised to 1500 kVar. While the reactive powers on all three DERs properly converged to the given setpoint, it is observed that the diesel settling time was 2.5 seconds longer than other two DERs due to its higher inherent inertia level, and this phenomenon was also observable on the sliding surface signals. At t=t2, a 10% Q-FDI was applied on the battery signal shared with the solar node. It was observed despite 0.025 deviation on the solar sliding surface, the Q sharing deviation was even less than 0.001 PU. This is attributed to the robustness of the proposed SMC consensus scheme to the applied cyber disturbance. By increasing the FDI intrusion to the 30% at t=t₃, the desirable Q sharing performance with minimized deviation was still maintained. This is mainly due to the presence of discontinuous sgn(·) switching function which performs consistently under increased cyber disturbance levels especially when the disturbance is bounded and pushes the states beyond continuous boundary layers. The exceeded deviation by introducing the 60% FDI at t=t₄ is detected by the CLQ unit and resulted in isolating the non-cooperative node and retrieving the sliding surface to the desired zero level. It could be seen that after disconnecting the battery node, the minor offset on Q signal was also eliminated. While this SMC scheme is designed to mitigate the severe impacts of cyber intrusions in the islanded mode of operation, these results confirmed the effectiveness of the SMC scheme disclosed for grid-tied operation mode as well.

Quantitative resilience analysis for consensus schemes under FDI attacks. To quantify the resilience level improvements attained by the novel scheme disclosed herein in the presence of FDI attacks, a comparative analysis between the conventional consensus and proposed scheme is presented in this section. For this purpose, a resilience index known by those skilled in the art was employed. The mathematical representation of the index is stated in Equation (39) as follows:

$$RI = 1 - \frac{{PF}_{before} - {PF}_{after}}{{PF}_{before}} \qquad ( 39 )$$

Where RI denotes the resilience index, the PF_{before} and PF_{after} are the performance functions before and after having the perturbation applied, respectively, which in this case was a minor 2% FDI attack on the voltage and frequency terms as discussed similarly in Case A and Case C test scenarios.

The performance function for the general variable x is given by Equation (40) as below:

$$PF = 1 - \frac{1}{T} {\int }_{0}^{T} ( \vert \frac{x - {x}_{n}}{{x}_{n}} \vert ) dt \qquad ( 40 )$$

Where T is the chosen time interval, x denotes any of the voltage, frequency, active-reactive power terms, and xₙ is either the nominal value or the value before perturbation moment for x.

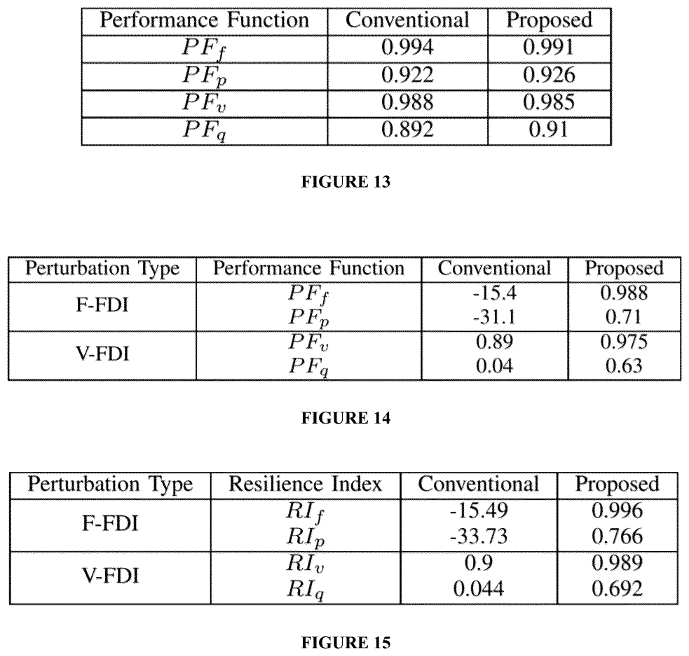

The performance function values for the condition where no FDI attack is still asserted, are presented in FIG. 13 for both conventional and proposed consensus schemes. For measuring these values, 5 seconds duration of frequency, voltage, active power, reactive power terms at the place of solar node (as the one which is affected the most by such FDI attacks) was evaluated under normal operating condition. While for frequency and voltage terms, the xₙ was adjusted with nominal values, the value latched at t=0 second was used for the power terms. In FIG. 14, the performance functions were quantified over a 5-seconds period where at t=0, the minor 2% FDI attack was asserted on the frequency or voltage terms. On the frequency FDI attacks, only the frequency and active power terms for solar node were evaluated, while for voltage FDI, the voltage and reactive power terms were measured. The calculated resilience index values are also presented in FIG. 15. Using this resilience index, the values closer to 1 show superior resilience, whereas the larger negative values represent being severely affected by the applied cyber perturbations. Due to the cumulative nature of this factor, the longer intervals would result in a lower performance function values and resilience indexes, especially on the highly deteriorated signals. For demonstration purposes, a 5 second interval on this case study was considered, which is the duration it takes for reaching the unstable condition on the conventional scheme.

Despite the satisfactory operation for normal operating condition of both schemes, the conventional scheme performance was highly deteriorated by the FDI attacks, specifically when a frequency cyber intrusion is applied. As previously the impacts of such FDI attacks on conventional scheme were discussed and demonstrated in Case A, the poor resilience to F-FDIs is confirmed by the low RI indexes of −15.49 and −33.73. However, the robust performance of the proposed SMC scheme has proven to be a more resilient solution where frequency and active power regulations are not heavily affected and the RI indexes are maintained by values marginally less than unity. The voltage term in conventional scheme was the least affected term which confirms the justification formulated by Equations (21) and (22).

The novel enhanced sliding mode consensus-based distributed control scheme disclosed is capable of more robust performance under the presence of cyberattacks. A cyber resilient offset compensation term on the sliding surfaces is employed to ensure superior steady state performance under normal operating condition, and to facilitate the control parameters adjustment for different operating conditions. While the robustness of the novel scheme to the system uncertainties and external disturbances can be further improved by increasing the sliding mode control gain values, the chattering effect is mitigated by means of replacing the discontinuous switching function with its continuous type within the surface boundary layer. The SMC robustness to cyber intrusions enables using less complex cyberattack detection schemes. Using a hysteresis-based communication link quality (CLQ) observer ensures that external perturbations on the distributed signals remain bounded to specific levels. The combination of SMC consensus with HCLQ observer enables a resilient distributed solution to cyber intrusions, where SMC counteracts the minor cyberattacks and HCLQ handles the higher intrusion levels by isolating the non-cooperative nodes once exceeding the specified threshold. The real time performance of the proposed control scheme was evaluated through the simulation model of an islanded AC microgrid consisting of three DERs on a real-time processor.

The presented simulation results confirmed the severe impacts of frequency FDI attacks on the microgrids regulated with conventional consensus schemes. It is shown that even a minor 2% FDI attack can force the converters toward the overloading condition and causes tripping of the protective circuits leading to an unstable operating condition. The duration it takes to have these detrimental effects interfering with the microgrid operation after FDI attack is applied depends on the microgrid control parameters, the electric connection line impedance values and the power rating of the converters. Despite the severe impacts of frequency FDIs, the voltage FDIs do not severely deteriorate the microgrid performance mainly due to the cancellation term introduced into the secondary regulation term. Using the novel SMC consensus scheme, the system robustness to the FDI attacks is highly improved as it can operate reliably under different levels of FDI attacks on the frequency, voltage and active-reactive power terms. To draw a comparison between the resilience levels on both schemes, a resilience index is incorporated which is based on evaluation of performance functions before and after the perturbations. Considering the cumulative nature of this index and the 5-second-long period considered for evaluation, the proposed scheme has resulted in resilience indexes marginally less than 1 while for conventional scheme the system resilience is only in acceptable range for the voltage term after V-FDI attack and the rest are highly deteriorated. The versatility of the proposed scheme is also verified for the Q-sharing between the microgrid converters operated in the grid connected mode.

The foregoing description sets forth exemplary methods, parameters, and the like. It should be recognized, however, that such description is not intended as a limitation on the scope of the present disclosure but is instead provided as a description of exemplary embodiments.

In the foregoing description of the disclosure and embodiments, reference is made to the accompanying drawings in which are shown, by way of illustration, specific embodiments that can be practiced. It is to be understood that other embodiments and examples can be practiced, and changes can be made, without departing from the scope of the disclosure.

In addition, it is also to be understood that the singular forms “a,” “an,” and “the” used in the following description are intended to include the plural forms as well unless the context clearly indicates otherwise. It is also to be understood that the term “and/or” as used herein refers to and encompasses all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Some portions of the detailed description that follow are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities as modules or code devices without loss of generality. It should be noted that the process steps and instructions of the present invention could be embodied in software, firmware, or hardware, and, when embodied in software, they could be downloaded to reside on, and be operated from, different platforms used by a variety of operating systems.

However, all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing,” “computing,” “calculating,” “determining,” “displaying,” or the like refer to the action and processes of a computer system, or similar electronic computing device, that manipulates and transforms data represented as physical (electronic) quantities within the computer system memories or registers or other such information storage, transmission, or display devices.

Although the description herein uses terms first, second, etc., to describe various elements, these elements should not be limited by the terms. These terms are only used to distinguish one element from another.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

The above description is presented to enable a person skilled in the art to make and use the disclosure, and it is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown but is to be accorded the widest scope consistent with the principles and features disclosed herein. Finally, the entire disclosure of the patents and publications referred in this application are hereby incorporated herein by reference.

We claim:

1. A cyber-resilient islanded alternating current microgrid comprising a plurality of distributed energy resources, wherein the distributed energy resources are organized in a hierarchical multi-layered regulation scheme comprising:
a primary level, comprising a plurality of local controllers for each distributed energy resource;
a secondary level, comprising a sliding mode consensus control scheme for each distributed energy resources; and
a tertiary level;
wherein the sliding mode consensus control scheme comprises:
an intrusion impact module;
an aggregate impact module;
a hysteresis-based communication link quality observer; and
a sliding mode switching control block;
wherein the outputs of the aggregate impact module and intrusion impact module are summed by an adder and inputted to the sliding mode switching control block; and
wherein a step-up function is applied to produce the change in a measure for the applicable distributed energy resource.

2. The microgrid of claim 1, wherein the local controllers of the primary control level distributed energy resources are structured to operate in a grid forming mode.

3. The microgrid of claim 1, wherein all distributed energy resources are configured in a master mode of operation.

4. The microgrid of claim 1, wherein the primary level comprises functionality to perform droop control.

5. The microgrid of claim 1, wherein each local controller comprises:
a voltage control;
a current control;
an adder;
an inverter; and
a point of common connection.

6. A method for increasing the cyber-resiliency of an islanded alternating current microgrid comprising:
(a) providing the microgrid, the microgrid comprising a plurality of distributed energy resources wherein the distributed energy resources are organized in a hierarchical multi-layered regulation scheme comprising:
i. a primary level, comprising a plurality of local controllers for each distributed energy resource, wherein the local controllers are configured in a grid forming mode;
ii. a secondary level, comprising a sliding mode consensus control scheme for each distributed energy resources;
iii. a tertiary level; and
iv. n nodes, comprising node i and node j;
wherein the sliding mode consensus control scheme comprises:
an intrusion impact module;
an aggregate impact module;
a hysteresis-based communication link quality observer; and
a sliding mode switching control block;
(b) assigning power set points for the local controllers in the secondary level;
(c) establishing an adjacency matrix for the microgrid, comprising a plurality of matrix elements, represented by aᵢⱼ;
wherein the adjacency matrix is of a size n×m; and
wherein the adjacency matrix is represented by:
$${A}_{n , n} = [ \begin{matrix}{a}_{1 , 1} & {a}_{1 , 2} & … & {a}_{1 , n} \\ {a}_{2 , 1} & {a}_{2 , 2} & … & {a}_{2 , n} \\ ⋮ & ⋮ & ⋱ & ⋮ \\ {a}_{n , 1} & {a}_{n , 2} & … & {a}_{n , n}\end{matrix} ]$$
(d) establishing a consensus-based update rule on a variable x for node i as:
$$\dot{{x}_{i}} = - {\sum }_{j = 1}^{n} {a}_{ij} ( {x}_{i} - {x}_{j} )$$
wherein the variable xᵢ on node i converges to a weighted average of its neighbor values xᵢⱼ with the time constant of
$${\sum }_{j = 1}^{n} {a}_{ij} .$$
(e) determining a regulation set point for the secondary level;
(f) determining the second layer frequency and voltage dependent control objectives;
(g) selecting one or more sliding surfaces, comprising two complimentary terms, comprising:
a first term, comprising functionality to perform first order dynamics to ensure convergence to reference values and minimizing any error terms; and
a second term, comprising functionality to counteract any introduced offsets through applied flexible adjustments.
(h) applying an exponential factor to each compensation term;
(i) converging state variables towards the sliding surfaces;
(j) retaining the state variables over the sliding surfaces; and
(k) enforcing sliding over a specified manifolds using discontinuous control signals.

7. The method of claim 6, wherein the local controllers of the primary control level distributed energy resources are structured to operate in a grid forming mode.

8. The method of claim 6, wherein all distributed energy resources are configured in a master mode of operation.

9. The method of claim 6, wherein the primary level comprises functionality to perform droop control.

10. The method of claim 6, wherein each local controller comprises:
a voltage control;
a current control;
an adder;
an inverter; and
a point of common connection.

11. The method of claim 6, wherein:
a value of the matrix elements of the adjacency matrix equals zero when there is no direct communication between node i and node j; and
the value of the matrix elements of the adjacency matrix is greater than zero when data is transferred between node i and node.

12. The method of claim 6, wherein the microgrid is configured for voltage and frequency sharing, and wherein the secondary layer regulation set point is determined by:
$$\{ \begin{matrix}\dot{{ω}_{i}} = - ( {\sum }_{j = 1}^{n} {a}_{ij} ( {ω}_{i} - {ω}_{j} ) + {k}_{ω i} ( {ω}_{i} - {ω}_{ref} ) ) \\ \dot{{V}_{i}} = - ( {\sum }_{j = 1}^{n} {a}_{ij} ( {V}_{i} - {V}_{j} ) + {k}_{Vi} ( {V}_{i} - {V}_{ref} ) )\end{matrix}$$
wherein k_{ωI} refers to a proportional control gains for regulation of a frequency ω in consideration of one or more reference values in the second layer; and
wherein k_{Vi} refers to a proportional control gains for regulation of a voltage V in consideration of one or more reference values in the second layer;

13. The method of claim 6, wherein the microgrid is configured for power sharing, and wherein the secondary layer regulation set point is determined by:
$$\{ \begin{matrix}\dot{{P}_{Ni}} = - {\sum }_{j = 1}^{n} {a}_{ij} ( {P}_{Ni} - {P}_{Nj} ) \\ \dot{{Q}_{Ni}} = - {\sum }_{j = 1}^{n} {a}_{ij} ( {Q}_{Ni} - {Q}_{Nj} )\end{matrix}$$
wherein P_{N}=(P÷P_{rated}) represents a normalized active power term with respect to a rated active power value for each node; and
wherein Q_{N}=(Q÷Q_{rated}) represents a normalized reactive power term with respect to a rated reactive power value for each node.

14. The method of claim 6, wherein the second layer frequency and voltage dependent control objectives are summarized by:
$${Δω}_{ω i} = {ω}_{ref} - {ω}_{i} \\ {Δω}_{ω ij} = {\sum }_{j = 1}^{n} {a}_{ω ij} ( {ω}_{j} - {ω}_{i} ) \\ {Δω}_{Pij} = {\sum }_{j = 1}^{n} {a}_{Pij} ( {P}_{Nj} - {P}_{Ni} )$$
wherein Δω_{ωi}, Δω_{ωij}, ΔωP_{ωi} represent frequency error terms for an agent i with respect to a reference frequency value, an adjacent neighboring frequency terms, and an adjacent neighboring active power terms, respectively; and
wherein α_{ωij}, αᵥᵢⱼ, α_{Pij}, α_{Qij} represent adjacency coefficients for frequency, voltage, active power and reactive power of node i, respectively, with respect to adjacent nodes as indexed by node j.

15. The method of claim 6, wherein the sliding surfaces are chosen by:
$${S}_{ω} = {S}_{ω 1} + {S}_{ω 2} \qquad ( 29 )$$
$${S}_{ω 1} = {Δω}_{ω i} + {Δω}_{ω ij} + {Δω}_{Pij} + {c}_{ω 1} ( \frac{d}{dt} {Δω}_{ω i} + \frac{d}{dt} {Δω}_{ω ij} + \frac{d}{dt} {Δω}_{Pij} ) \qquad ( 30 )$$
$${S}_{ω 2} = {K}_{Pij} . {e}^{- {K}_{ω exp} \vert {Δω}_{ω ij} \vert} , {Δω}_{ω ij} \qquad ( 31 )$$
$${S}_{v} = {S}_{v 1} + {S}_{v 2} \qquad ( 32 )$$
$${S}_{v 1} = {ΔV}_{vi} + {ΔV}_{vij} + {ΔV}_{Qij} + {c}_{v 1} ( \frac{d}{dt} {ΔV}_{vi} + \frac{d}{dt} {ΔV}_{vij} + \frac{d}{dt} {ΔV}_{Qij} ) \qquad ( 33 )$$
$${S}_{v 2} = {K}_{Qij} . {e}^{- {K}_{vexp} \vert Δ {V}_{vij} \vert} , {ΔV}_{vij} \qquad ( 34 )$$
wherein S_{ω}, Sᵥ denote an overall selected sliding surface and S_{ω1}, Sᵥ₁ represent the first sliding surface term for the secondary layer sliding mode consensus control of frequency and voltage terms, respectively;
wherein c_{ωI} and c_{vI} constants denote corresponding design constant gains for the sliding surfaces selected; and
wherein the K_{Pij} and K_{Qij} constants represent offset compensation gains for addressing surface deviations introduced by active and reactive power terms.
